(19) United States
(12) Patent Application Publication
(10) Pub. No.: US 2005/0187783 A1
(43) Pub. Date: Aug. 25, 2005

(54) System for personalized combo kit of tools and accessories

(75) Inventors: David Robert Johnston, Jackson, TN (US); Alan Phillips, Jackson, TN (US)

Correspondence Address: HARNESS, DICKEY & PIERCE, P.L.C., P.O. BOX 828, BLOOMFIELD HILLS, MI, 48303, US

(73) Assignee: BLACK & DECKER INC., Newark, DE (US)

(21) Appl. No.: 11/062,326

(22) Filed: Feb. 18, 2005

Related U.S. Application Data
(60) Provisional application No. 60/546,684, filed on Feb. 20, 2004.

(51) Int. Cl. G06F 17/60

(52) U.S. Cl. 705/1; 705/8; 705/26

(57) ABSTRACT

A personalized combo kit of tools and accessories is assembled by the customer using a personalization system. A plurality of tools and accessories are provided to a customer for selection. The customer is enabled to select at least two items from the plurality and the selected items are offered to the customer at a discount price. The personalization system performs a compatibility check to determine that the tool components selected are compatible and thus eligible for inclusion as part of the combo kit. The personalization system assists in determining the offered price based on compatibility checking results.

### CROSS-REFERENCE TO RELATED APPLICATIONS

The present invention claims the benefit under 35 USC §119(e) of U.S. Provisional Application Ser. No. 60/546,684, filed Feb. 20, 2004, which is herein incorporated by reference in its entirety.

### FIELD OF THE INVENTION

The present invention relates generally to tools and their accessories and particularly to a system and method for providing and/or selling a personalized combo kit of tools and their accessories.

### BACKGROUND OF THE INVENTION

Tools and their accessories are often sold today as fixed, pre-configured combo kits, containing a plurality of items that market research has shown would likely be purchased together. For example, a pre-configured cordless tool combo kit might be sold as a combination of components such as a cordless drill, a cordless reciprocating saw, a cordless flashlight, a battery charger and two batteries. Such preconfigured combo kit may be offered at a discounted price, reflecting the fact that fewer batteries are supplied than would be provided if each item were sold separately and further reflecting the fact that the packaging is shared by multiple components. The pre-configured combo kit is beneficial to the customer because the customer pays less than if he or she bought each component separately. The pre-configured combo kit is also beneficial to the manufacturer and distributor because they can sell more products at one time than they would if each component were sold separately.

However, the pre-configured combo kit has some shortcomings. For one, retail shelf space is at a premium. It is simply not feasible to stock preconfigured combo kits in all permutations of different components that a consumer might want to purchase. Thus manufacturers must rely on market research to predict which combinations of components will sell the best and thus maximize the utility of the retail shelf space. This means that in some cases, where the market research does not predict customer demand accurately, some pre-configured combo kits may languish on the retail shelves while other popular combo kits will go out of stock.

Consumers likewise suffer because certain pre-configured combo kits may not be offered at all. This forces the consumer to purchase individual tools that will necessarily include components the consumer may already have and thus would otherwise not wish to purchase.

In general, to maximize the economic advantages of the combo kit, one will preferably unbundle the working end of the tool from it's power source, so that they may be offered for sale separately. There are a number of different classes of tools where such unbundling is beneficial and/or convenient. Cordless tools represent one large class of such products where the tool power source (rechargeable battery and its associated battery charger) might be shared among several different types of tools. Pneumatic tools such as impact wrenches, brad nailers and the like, represent another such class where the power source (air compressor) might be shared across different types of tools if the manufacturer or distributor had a convenient way to unbundled the tool from its power source.

The unbundling of the working end of a tool from its power source in the commercial setting is not as straightforward as one might think. When developing pre-configured combo kits for sale, manufacturers or distributors need to be mindful of two aspects. First, when unbundling the working end of a tool from its power source (so that these may be sold in different combo kits) the compatibility of the working end of the tool with its power source must be ensured. For example, a cordless drill designed to operate at 19.2 volts would not be compatible with a 14.4 volt or 12 volt power source. Second, when selecting multiple tools for inclusion in a combo kit, care must be given to ensure compatibility among tools. Again, there would be little commercial advantage in offering a combo kit that bundles a 12 volt cordless drill with a 19.2 volt circular saw because the power source could not be shared.

Thus it is desirable to provide a flexible, personalized combo kit, which may allow the customer to have more selections of components within the kit, and while allowing the manufacturer or distributor to profitably offer the personalized combo kit at a discounted price. It is also desirable to provide a flexible, personalized combo kit, which allows the manufacturer or distributor to carry a lower inventory and to better forecast the customer demand, thereby reducing the cost of manufacture and delivery.

### SUMMARY OF THE INVENTION

The present invention provides a system and method to provide a personalized combo kit of tools and accessories that works well in both traditional brick and mortar retail stores and web-based (internet) stores. The system employs a data store of product compatibility information that may be automatically accessed by a retail processing system (e.g., retail computer system or e-commerce system) to assess whether the individual components selected by the customer are both compatible with the chosen power source and/or complementary with other components previously selected during the present transaction or a prior transaction.

In the retail store environment, the system may interact with a product scanner, such as a barcode scanner, to automatically access the compatibility data store to verify that the item or items selected by the customer are appropriate for inclusion in a personalized combo kit. In the e-commerce environment the customer selects products through a suitable user interface, such as through a web site accessed using a browser, and the customer's selections are automatically checked by consulting the compatibility data store as in the case of the retail environment. Based on the outcome of the compatibility check, the system may calculate the price of the personalized combo kit, applying a price discount or rebate based on predefined discounting rules.

According to one exemplary aspect of the present invention, a method for providing a personalized combo kit of tools and accessories includes the following steps. A plurality of tools and accessories are provided to a customer for selection. The customer is enabled to select at least two items from the plurality of tools and accessories. The selected at least two items are offered to the customer at a discount price (e.g., at a lower price or along with a rebate).

According to an additional exemplary aspect of the present invention, a method for providing a personalized combo kit of tools and accessories online includes the following steps. A plurality of tools and accessories are provided to a customer for selection via the Internet. The customer is enabled to select at least two items from the plurality of tools and accessories via the Internet. The selected at least two items are offered to the customer at a discount price (or offered with a rebate) via the Internet.

According to another exemplary aspect of the present invention, a computer-readable medium having computer-executable instructions for performing a method of providing a personalized combo kit of tools and accessories is provided. The method includes the following steps. A plurality of tools and accessories are provided to a customer for selection. The customer is enabled to select at least two items from the plurality of tools and accessories. The selected at least two items are offered to the customer at a discount price or together with a rebate.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention. Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating the personalization system whereby a personalized combo kit is assembled by the customer by selecting individual components;

FIG. 2 is a system block diagram of a presently preferred implementation for use in a retail environment;

FIG. 3 is a system block diagram of a presently preferred implementation for use in an e-commerce environment;

FIG. 4 is a flow chart of an exemplary method for providing a personalized combo kit of tools and accessories in accordance with an exemplary embodiment of the present invention; and

FIG. 5 is a flow chart of an exemplary method for providing a personalized combo kit of tools and accessories online in accordance with an exemplary embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

The present invention may enable the customer to create a variety of tool and accessories combinations for purchase, which may meet the customer's specific needs. In one embodiment, at a point of sale such as a store, shop, online store (e.g., through the Internet), or the like, the customer is provided with a choice for personalizing a combo kit of tools and accessories. The customer may select, mix, and match products to create its own personalized combo kit with corresponding discounted pricing. In another embodiment, an online customer may be able to select from a broad range of tools and/or accessories to create a unique combination tool kit. In both embodiments, an automated personalization system may be used to mediate the product selection and personalized combo kit definition.

By allowing the customer to select from a variety of tools and related accessories, the customer may personalize or customize the tool set for specific professions and/or jobsite requirements. For example, an installer of kitchen cabinets may elect to combine two cordless drills, three batteries, and a charger with a carrying case, while a plumber may configure his/her kit with a hammerdrill, two batteries, and a reciprocal saw with no carrying case. The personalization or customization process may be greatly enhanced via the Internet due to no restrictions on the retail space, no merchandising components, and the prevailing shopping behavior at online stores where customers pick and choose to add items to the online shopping cart.

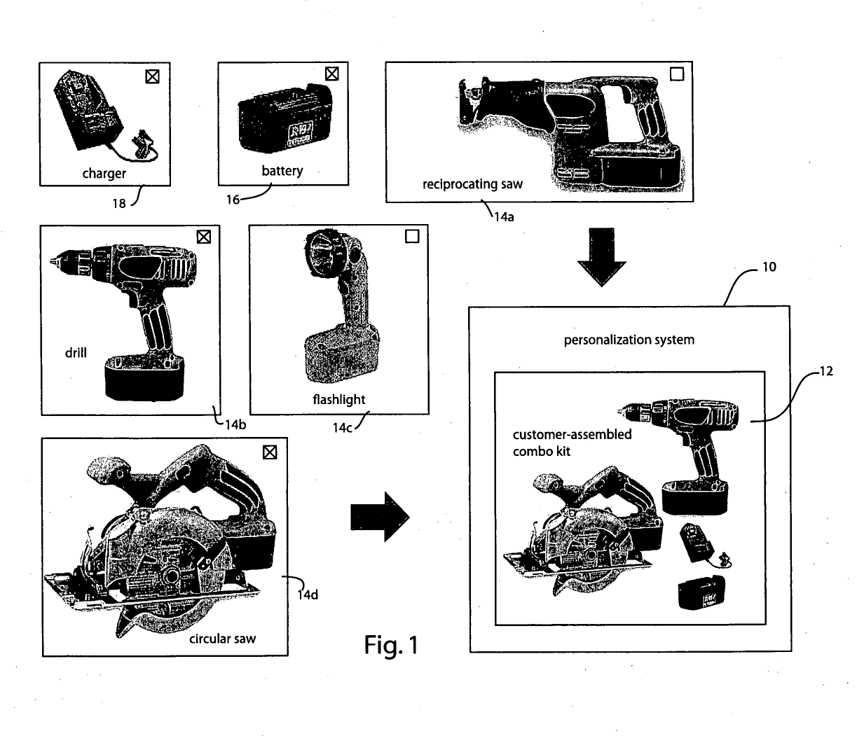

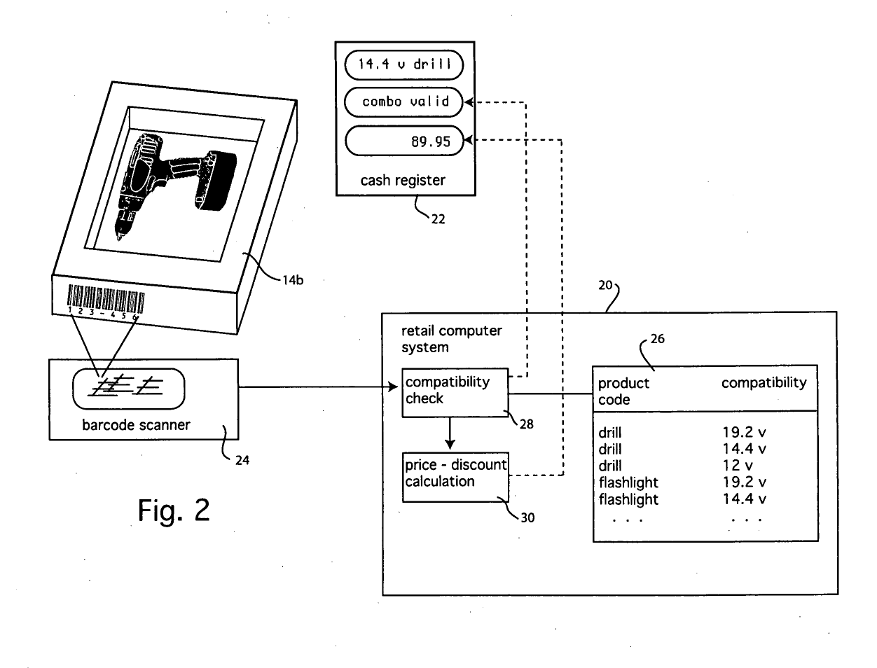

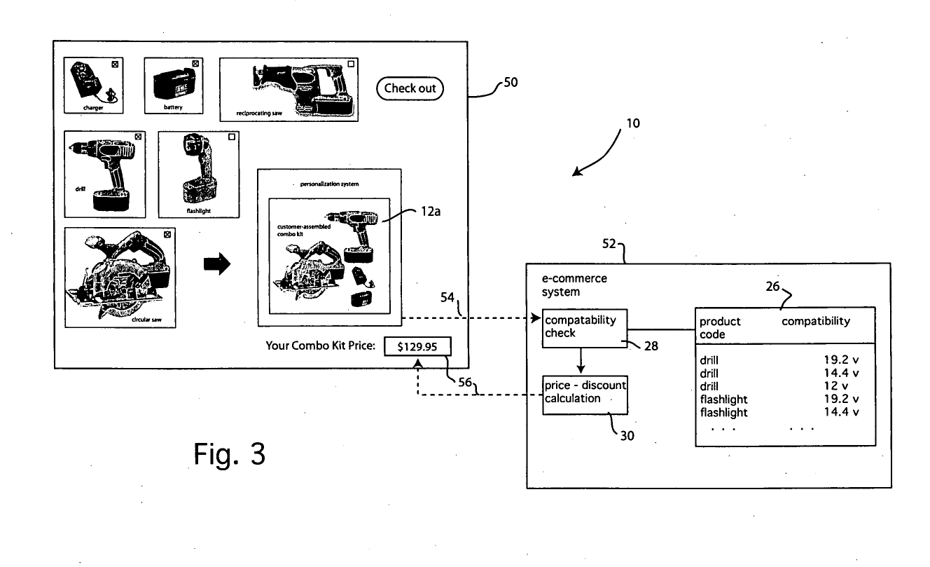

Referring to FIG. 1, a personalization system is illustrated generally at 10. Different implementation of the personalization system will be presented in connection with FIGS. 2 and 3 below. Essentially, the personalization system automates and mediates the process whereby the customer assembles a personalized combo kit 12 by selecting among the plurality of individual components. Included in the plurality of components are tool working end components 14a-14d and at least one power source component such as rechargeable battery 16 and charger 18.

In this regard, it will be noted that the tool working ends are those components that actually effect a change to or perform work upon a workpiece. Components such as the reciprocating saw 14b, drill 14a and circular saw 14e perform physical work upon a workpiece as by cutting, boring, drilling, routing, abrading, and the like. Flashlight 14c provides illumination that may be directed to impinge upon a workpiece or otherwise generally illuminate an area.

In contrast, the power source, such as battery 16 and its associated charger 18 are components that generally do not perform work directly upon a workpiece, but rather they supply energy to the working end of the tool so that the working end of the tool can perform work upon the workpiece. This distinction is made to emphasize that a complete and operative tool will generally require both a working end component and a power source component. Moreover, these two components must be compatible with one another if the tool is to operate properly.

Referring now to FIG. 2, a retail environment implementation of the personalization system has been illustrated. Although the personalization system can be implemented on a variety of different computing platforms, it will often be convenient to implement the personalization system by including it as part of the retail computer system 20. The personalization system can be implemented on a separate server attached through suitable local area network or wide area network (including via the internet) to the in-store computer system that is coupled to the cash register 22 and its associated product barcode scanner 24 or RF-ID tag reader. Alternatively, the functionality provided by the personalization system can be programmed to run on the in-store computer system itself.

The personalization system includes a compatibility data store 26 in which individual products or components thereof are stored. Data store 26 is preferably configured so that each product or component has a unique identifier code that is associated with a compatibility indicia. For purposes of illustration, FIG. 2 illustrates several cordless tool products where the suitable compatibility indicia may be the voltage value of the required rechargeable battery for that tool.

The personalization system employs a compatibility check module 28 that is coupled to the product barcode scanner 24. As each product is scanned at the checkout counter its respective code is stored in memory within computer system 20 and the compatibility check module 28 uses the product code to look up the compatibility indicia. As each subsequent product is scanned, the compatibility check module determines whether the products are compatible with a common power source and are thus complementary. The compatibility check module 28 may be configured with a rules set to determine whether components are complementary with one another. In one embodiment, components are deemed complementary if they are compatible with the same power source and that they are different from one another. In this embodiment, the personalization system would not permit a customer to purchase multiple drills, for example, at a discounted price just because they all use the same battery. Although the customer might be permitted to purchase these items, they would not be deemed as qualifying as a valid combo kit for price reduction. In another embodiment, complementary is defined as simply being capable of using the same power source. In this embodiment, a customer would be permitted to purchase multiple drills, for example, and receive the combo kit price so long as all drills share the same power source requirements.

The personalization system may further include a price-discount calculation module 30 that determines the price of the personalized and/or an applicable discount based on the results of the compatibility check module 28. The price-discount calculation module 30 may be preprogrammed with pricing and discounting rules to apply different pricing schemes to different combinations of components (the discount may be offered as a price reduction or in the form of a rebate which may be redeemed in a variety of ways including cash back and as an in store credit to be used to purchase other items). These rules can be input to the retail computer system by programming the computer system directly or by providing the rules to the computer system over a suitable local area network or wide area network (including the internet). If desired, the price-discount calculation module 30 can supply an output to the cash register 22 to allow the consumer and/or checkout clerk to view the calculated price of the combo kit. Similarly, the compatibility check module 28 can supply an output to the cash register 22 to provide an indication as to whether a particular item scanned qualifies for inclusion in the combo kit.

If desired, the personalization system can be configured to keep track of multiple different personalized combo kits during a single commercial transaction. For example, if the customer has elected to assemble two personalized combo kits, one at a first power source voltage and one at a second power source voltage, the compatibility check module 28 may keep track of both combo kits separately, thereby allowing the customer make multiple combo kit purchases at a single time. The compatibility check module 28 is thus intelligent enough to recognize that a scanned component may qualify as complementary with one group of components, even though it is not complementary with a different group of components being purchased at the same time.

Referring to FIG. 3, an e-commerce implementation of the personalization system has been illustrated. In this implementation the basic workings of the compatibility data store 26, the compatibility check module 28 and the price-discount calculation module 30 are essentially the same as was discussed in connection with FIG. 2. These components may be implemented on one or more servers connected together over a suitable local area network or wide area network (including the internet). Moreover, these components can be configured using client-server architecture so that the data store 26, compatibility check module 28 and price-discount calculation module 30 do not necessarily need to reside on the same computer, although they may.

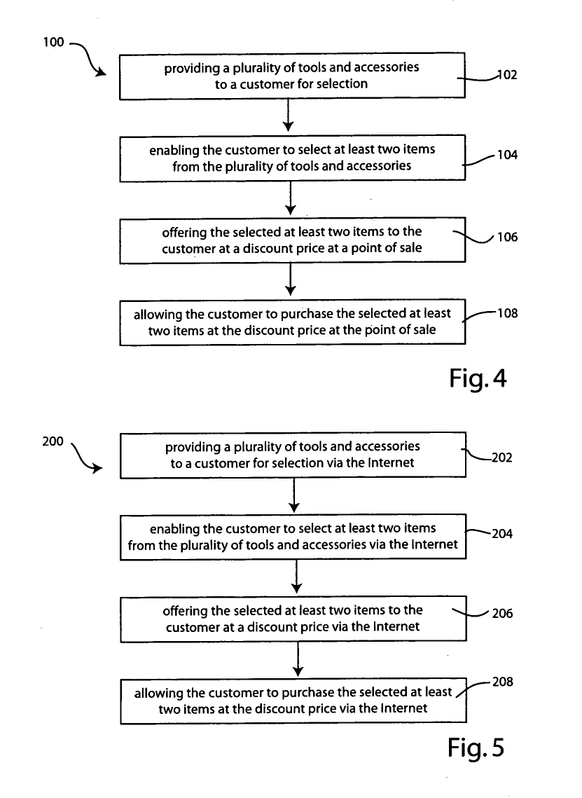

The main difference between the embodiment of FIG. 3 and that of FIG. 2 lies with the user interface. In the retail embodiment of FIG. 2 the interface took the form of a cash register with suitable display and barcode scanner. In the embodiment of FIG. 3, the interface may be provided on a computer display such as through a web page 50. The user would select components for inclusion in a virtual combo kit 12a and the e-commerce system 52 harvests the user's selections as at 54, performs the compatibility check and price-discount calculation and then supplies a combo price back to the user as at 56. E-commerce shopping cart technology may then be employed to consummate the commercial transaction whereby the user places his or her order and provides appropriate payment information and product delivery information. Having thus described the personalization system in connection with several embodiments for retail store and e-commerce applications, a further description of the exemplary methods will now be provided in connection with FIGS. 4 and 5.

Now referring to FIG. 4, a flowchart of an exemplary method 100 for providing a personalized combo kit of tools and accessories in accordance with an exemplary embodiment of the present invention is shown. A plurality of tools and accessories are provided to a customer for selection 102. The plurality of tools and accessories may be selected from cordless tools, power tools, air compressors, air tools, pressure washers, and related accessories, and the like. Preferably, the plurality of tools and accessories include a base kit. A base kit may be tools only, accessories only, or a combination of tool and accessory. For example, a base kit may include two batteries, a charger and a carrying case (or bag). The customer is enabled to select at least two items from the plurality of tools and accessories 104. Preferably, the selected items include the base kit. The selected items are offered to the customer at a discount price at a point of sale such as a store, shop, online store (e.g., via the Internet, Intranet, etc.), or the like 106. The customer is allowed to purchase the selected items at the discount price at the point of sale 108.

FIG. 5 is a flowchart of an exemplary method 200 for providing a personalized combo kit of tools and accessories online in accordance with an exemplary embodiment of the present invention. A plurality of tools and accessories are provided to a customer for selection via the Internet 202. The plurality of tools and accessories may be selected from cordless tools, power tools, air compressors, air tools, pressure washers, and related accessories, and the like. Preferably, the plurality of tools and accessories include a base kit. A base kit may be tools only, accessories only, or a combination of tool and accessory. For example, a base kit may include two batteries, a charger and a carrying case (or bag). The customer is enabled to select at least two items from the plurality of tools and accessories via the Internet 204. Preferably, the selected items include the base kit. The selected items are offered to the customer at a discount price via the Internet 206. The customer is allowed to purchase the selected items at the discount price via the Internet 208.

It is understood that the present invention may also be applied to any other product in a retail environment, whether online or offline, without departing from the scope and spirit of the present invention.

The present invention may provide the following advantages. First, the manufacture/distributor may be able to carry a lower inventory and better forecast the customer demand, therefore lowering the cost of doing business. Moreover, the customer may be able to have more selections of products with discounted pricing.

It is to be noted that the above described embodiments according to the present invention may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the present invention may be conveniently implemented in forms of software package. Such a software package may be a computer program product which employs a computer-readable medium including stored computer code which is used to program a computer to perform the disclosed function and process of the present invention. The computer-readable medium may include, but is not limited to, any type of conventional floppy disks, optical disks, CD-ROMS, magneto-optical disks, ROMs, RAMs, EPROMs, EEPROMs, magnetic or optical cards, or any other suitable media for storing electronic instructions.

It is understood that the specific order or hierarchy of steps in the processes disclosed is an example of exemplary approaches. Based upon design preferences, it is understood that the specific order or hierarchy of steps in the processes may be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

The description of the invention is merely exemplary in nature and, thus, variations that do not depart from the gist of the invention are intended to be within the scope of the invention. Such variations are not to be regarded as a departure from the spirit and scope of the invention.

1. A personalization system for mediating the commercialization of a personalized combo kit of tools, comprising:
an interface through which a customer's selection of a tool component for inclusion in the personalized combo kit is expressed;
a data store containing records of a plurality of tool components and a related compatibility indicia;
a compatibility checking system that accesses said data store to determine if said customer's selection of a tool component is compatible with other customer-selected tool components;
a price calculation system that determines a price associated with the personalized combo kit based on the identity of tool components deemed compatible by said compatibility checking system.

2. The personalization system of claim 1 wherein said interface includes a barcode scanner or RF-ID tag reader.

3. The personalization system of claim 1 wherein said interface includes an e-commerce web site.

4. The personalization system of claim 1 wherein said compatibility indicia corresponds to the power supply requirements of a tool component.

5. The personalization system of claim 1 wherein said compatibility checking system includes a rule set that deems tool components compatible if they have the same power supply requirements.

6. The personalization system of claim 1 wherein at least one of said data store, compatibility checking system and price calculation system are hosted by a retail computer system.

7. The personalization system of claim 1 wherein at least one of said data store, compatibility checking system and price calculation system are hosted by an e-commerce computer system.

8. The personalization system of claim 1 wherein said price calculation system determines a price discount or rebate based on the identity of tool components that are deemed compatible by said compatibility checking system.

9. The personalization system of claim 1 wherein said personalization system is configured by a predetermined set of rules.

10. The personalization system of claim 9 further comprising mechanism for updating said predetermined set of rules by communicating with said personalization system via a computer network.

11. A method for providing a personalized combo kit of tools and accessories, comprising:
providing a plurality of tools and accessories to a customer for selection;
enabling said customer to select at least two items from said plurality of tools and accessories; and
offering said selected at least two items to said customer at a discount price at a point of sale.

12. The method of claim 11, wherein said plurality of tools and accessories include a base kit.

13. The method of claim 12, wherein said selected at least two items include said base kit.

14. The method of claim 11, wherein said plurality of tools and accessories include at least one of a cordless tool, a compressor, an air tool, a power tool, or a pressure washer.

15. The method of claim 11, wherein said point of sale is an online store.

16. The method of claim 11, wherein said point of sale is a store.

17. The method of claim 11, further comprises allowing said customer to purchase said selected at least two items at said discount price at said point of sale.

18. A method for providing a personalized combo kit of tools and accessories online, comprising:
providing, via Internet, a plurality of tools and accessories to a customer for selection;
enabling said customer to select at least two items from said plurality of tools and accessories via the Internet; and
offering, via the Internet, said selected at least two items to said customer at a discount price.

19. The method of claim 18, wherein said plurality of tools and accessories include a base kit.

20. The method of claim 19, wherein said selected at least two items include said base kit.

21. The method of claim 11, wherein said plurality of tools and accessories include at least one of a cordless tool, a compressor, an air tool, a power tool, or a pressure washer.

22. The method of claim 11, further comprises allowing said customer to purchase said selected at least two items at said discount price via the Internet.

23. A computer-readable medium having computer-executable instructions for performing a method of providing a personalized combo kit of tools and accessories, said method comprising:
providing a plurality of tools and accessories to a customer for selection;
enabling said customer to select at least two items from said plurality of tools and accessories; and
offering said selected at least two items to said customer at a discount price at a point of sale.

24. The computer-readable medium of claim 23, wherein said plurality of tools and accessories include a base kit.

25. The computer-readable medium of claim 24, wherein said selected at least two items include said base kit.

26. The computer-readable medium of claim 23, wherein said plurality of tools and accessories include at least one of a cordless tool, a compressor, an air tool, a power tool, or a pressure washer.

27. The computer-readable medium of claim 23, wherein said point of sale is an online store.

28. The computer-readable medium of claim 23, wherein said point of sale is a store.

29. The computer-readable medium of claim 11, wherein said method further comprises allowing said customer to purchase said selected at least two items at said discount price at said point of sale.
